(19) United States
(12) Patent Application Publication
(10) Pub. No.: US 2025/0234261 A1
(43) Pub. Date: Jul. 17, 2025

(54) METHODS AND DESIGN FOR LINK MANAGEMENT FOR SEAMLESS ROAMING IN UHR COMMUNICATION NETWORKS

(71) Applicants: SONY GROUP CORPORATION, Tokyo (JP); SONY CORPORATION OF AMERICA, New York, NY (US)

(72) Inventors: Qing Xia, San Jose, CA (US); Salvatore Talarico, Los Gatos, CA (US)

(73) Assignees: SONY GROUP CORPORATION, Tokyo (JP); SONY CORPORATION OF AMERICA, New York, NY (US)

(21) Appl. No.: 18/925,218

(22) Filed: Oct. 24, 2024

Related U.S. Application Data
(60) Provisional application No. 63/620,079, filed on Jan. 11, 2024.

(51) Int. Cl. H04W 36/18; H04W 8/26; H04W 28/16

(52) U.S. Cl. CPC H04W 36/18; H04W 8/26; H04W 28/16

(57) ABSTRACT

Ultra High Reliability (UHR) operation under IEEE 802.11 be provides an inner connection between a central controller and multiple AP or AP MLDs through a backhaul connection. Enhancements are described herein for overcoming roaming conflict issues using new link management functionalities directed to the new UHR architecture including a Global Link ID, Global AID, Global AID Bitmap and changes to link management negotiation and operations toward attaining seamless roaming. In addition, a Partial Virtual bitmap in TIM element, and a Global Multi-Link Traffic Indication element support these operations.

### CROSS-REFERENCE TO RELATED APPLICATIONS

This application claims priority to, and the benefit of, U.S. provisional patent application Ser. No. 63/620,079 filed on Jan. 11, 2024, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to wireless networks under IEEE 802.11, and more particularly to reducing link management negotiation for an Ultra High Reliability (UHR) roaming station.

### 2. Background Discussion

IEEE P802.11 bn has been established to enhance the base functionalities of IEEE P802.11 be toward providing wireless connectivity for fixed, portable, and moving stations within a local area, while adding Ultra High Reliability (UHR) capability. The UHR capability provides increased throughput, reduced latency, and reduced MAC Protocol Data Unit (MPDU) loss compared to the Extremely High Through (EHT) operation defined in IEEE P802.11 be. However, issues arise in regard to seamless roaming for non-AP stations from one BSS to another.

Accordingly, a need exists for improved mechanisms toward achieving seamless UHR roaming operations. The present disclosure fulfills that need and provides additional benefits over existing systems.

### BRIEF SUMMARY

Mechanisms are described to enhance seamless UHR roaming for Multiple Link Devices (MLDs) in different Basic Service Sets (BSSs) connecting with the same central controller. The AP MLDs can support the same or different link configurations and operation capabilities on each supporting operating link. The AP MLD negotiates for global link management with a non-AP MLD, with no renegotiation requires before roaming occurs to the AP MLD of the target BSS. Each UHR AP MLD has a global AP MLD ID, and can assign Global Link IDs to each of its operating links, wherein none of its operating links have the same Global Link ID as another link. Different forms of Global Link ID are described. A Global AID Bitmap element is configured to adapt the AID value to a global AID value. A Global TID-To-Link Mapping (TTLM) element is configured to indicate whether to enable the global TTLM capability and to adapt the length of the Link Mapping of TID ‘n’ field to fit the Global Link ID. A Global Multi-Link Traffic Indication element is configured to contain a list of per-link traffic indication bitmap(s) corresponding to the Global Link ID and Global AID for non-AP MLDs. A Multi-Link element is designed to carry capabilities and supported operation information for multiple AP MLDs in the same Multi-Link element.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station hardware, according to at least one embodiment of the present disclosure.

FIG. 2 is a block diagram of Multi-Link Device (MLD) hardware according to at least one embodiment of the present disclosure.

FIG. 3A and FIG. 3B is a block diagram of a central controller architecture according to at least one embodiment of the present disclosure.

FIG. 4 is data field diagram of a Global Link ID Information field according to at least one embodiment of the present disclosure.

FIG. 5 is data field diagram of subfields within the Global Link ID field seen in FIG. 4, according to at least one embodiment of the present disclosure.

FIG. 6 is data field diagram of a Global Association ID (AID) Bitmap element according to at least one embodiment of the present disclosure.

FIG. 7 is data field diagram of a Partial Global AID Bitmap Length field, according to at least one embodiment of the present disclosure.

FIG. 8 is data field diagram of a Global TTLM element, according to at least one embodiment of the present disclosure.

FIG. 9 is data field diagram of a TID-To-Link Control field format according to at least one embodiment of the present disclosure.

FIG. 10 is data field diagram of a Global Multi-Link Traffic Indication element, according to at least one embodiment of the present disclosure.

FIG. 11 is data field diagram of a Multi-Link Traffic Indication Control field, according to at least one embodiment of the present disclosure.

FIG. 12A and FIG. 12B is data field diagram of a Global Multi-Link Traffic Indication element, according to at least one embodiment of the present disclosure.

FIG. 13 is data field diagram of a Per-Link Traffic Indication Bitmap ‘n’ subfield, according to at least one embodiment of the present disclosure.

FIG. 14A and FIG. 14B is data field diagram of a Global Central Controller Connected Multi-Link Traffic Indication element, according to at least one embodiment of the present disclosure.

FIG. 15 is data field diagram of a Per-Link Traffic Indication Bitmap ‘n’ subfields, according to at least one embodiment of the present disclosure.

FIG. 16 is data field diagram of a Per-Link traffic indication List field format, according to at least one embodiment of the present disclosure.

FIG. 17 is data field diagram of a Multi-Link element format, according to at least one embodiment of the present disclosure.

FIG. 18 is data field diagram of a Presence Bitmap subfield, according to at least one embodiment of the present disclosure.

FIG. 19 is data field diagram of a common Information field of the Basic Multi-Link element, according to at least one embodiment of the present disclosure.

FIG. 20A through FIG. 20C are roaming communication diagrams for a target MLD having fewer link that the originating MLD, according to at least one embodiment of the present disclosure.

FIG. 21A through FIG. 21C are roaming communication diagrams for a target MLD having more links that the originating MLD, according to at least one embodiment of the present disclosure.

### DETAILED DESCRIPTION

### 1. Introduction to IEEE 802.11 be

In IEEE P802.11 be, each Multiple Link Device (MLD) has a single Medium Access Control (MAC)-Service Access Point (SAP), thus MAC-SAP, and has one or more STAs affiliated with it. A MLD manages multiple links through the corresponding affiliated stations (STAs). There is no backhaul connection between different MLDs.

An Access Point (AP) MLD assigns a link identifier (ID) to its affiliated AP and the link that the AP is operating on has an integer value between 0 and 14. A non-AP MLD obtains the link ID assigned to an affiliated AP during discovery and uses this link ID value for all multi-link (ML) operations that involve this affiliated AP.

A TID-To-Link Mapping (TTLM) mechanism is designed in IEEE P802.11 be which allows the AP MLD and non-AP MLD that performed ML setup to determine the manner in which the Data frame belonging to TIDs 0-7 and Management frames will be assigned for transmission, on the setup links between the two MLDs in DownLink (DL) and UpLink (UL). A default TTLM indicates all Traffic Identifiers (TIDs) shall be mapped to all setup links for both DL and UL. A non-default TTLM procedure indicates to map specific TID(s) to a link set, which needs to be either negotiated between the AP MLD and non-AP MLD pair, or have been advertised in the Beacon and/or Probe Response frames by the AP MLD. The TTLM element can be carried in the Probe Response or Beacon frame, Probe Response, (Re)Association Response frame, TID-To-Link Mapping Request frame, TID-To-Link Mapping Response frame, and/or TID-To-Link Mapping Teardown frame.

An AP affiliated with an AP MLD may schedule for transmission a Link Recommendation frame to provide link recommendation for a set of non-AP MLDs, which are identified by the Association IDs (AIDs) that are indicated in the Partial AID Bitmap subfield of the AID Bitmap element. One or more links can be recommended by the AP MLD to a non-AP MLD. The recommended links are identified by the link ID and are indicated in the Per-Link Traffic Indication Bitmap subfield in the Multi-Link Traffic Indication element. Both AID Bitmap element and Multi-Link Traffic Indication element can be carried in a Link Recommendation frame. If a non-AP MLD receives a Link Recommendation frame with the bit corresponding to its AID set to a first state (e.g., “1”) in the Partial AID Bitmap subfield of the AID Bitmap element in the Link Recommendation frame, it should exchange frames both in DL and UL on enabled links identified as recommended in the Multi-Link Traffic Indication element in the Link Recommendation frame while following the rules defined in TTLM.

IEEE P802.11 be defines different MLD operations, including Simultaneous Transmit and Receive (STR), Non-simultaneous Transmit and Receive (NSTR), Enhanced Multi-Link Single-Radio (EMLSR) and Enhanced Multi-Link Multi-Radio (EMLMR), etc. The MLD capabilities and operations are negotiated during an association stage. A STA will perform corresponding rules after determining that the capability is supported as indicated in the Basic Multi Link element. MLD capabilities and operations of the current BSS can be advertised in transmitted Beacon, Probe Response, and (Re)Association Response frames from the AP and can be carried in the transmitted (Re)Association Request frame from a non-AP STA affiliated with a non-AP MLD.

### 2. Problem Statement

Operating in UHR mode may have a new architecture deployed with a central controller to provide inner connection between multiple APs or AP MLDs through a backhaul connection, such as fiber or wireless ultra-wide broad band (Terahertz) communication. The new architecture can benefit the Multiple AP (M-AP) coordination and provides support to seamless roaming. However, the non-AP devices, associating with either the central controller or any of its affiliated AP or AP MLD, can encounter management conflicts between different BSSs during roaming. These management conflicts arise from different link management perspectives, including the following.

### 2.1.1. Conflicts Regarding Link ID

In the 802.11 be specification, the link ID is a local ID, meaning that each AP or AP MLD assigns the link ID values to its operating links independently. For example, the AP MLD of the original BSS before roaming assigns the 5 GHz link with link ID: 1 and the AP MLD of the roaming target BSS assigns the 6 GHz link with link ID: 1. This unsynchronized information can easily lead to misunderstandings when processing coordination among multiple BSSs.

2.1.2. Conflicts of AID of Roaming non-AP MLD

In the 802.11 be specification, the AP MLD shall set the bit in the partial virtual bitmap of the Traffic Indication Map (TIM) element that corresponds to the AID of the non-AP MLD to a first state (e.g., “1”) to indicate that the AP MLD has Buffered Unit(s) (BUs) for that non-AP MLD. However, the AID assigned by one AP MLD is not understood by another AP MLD and may conflict with an existing AID when the roaming non-AP MLD roams to the target BSS. A new design is therefore needed to resolve this issue.

### 2.1.3. Conflicts in TID-To-Link Mapping (TTLM)

In the 802.11 be specification, before transmitting over an enabled link, the Quality-of-Service (QoS) Data frames should have their TIDs mapped to enable links in the direction (DL/UL) corresponding to the TTLM. Other than this, the BlockAck Req frame shall not be transmitted on the link in both DL and UL directions if the corresponding TID(s) are not mapped to that link. However, different BSSs may have the same TID mapped to different links. For example, the roaming STA with traffic of TID 7, which when transmitted during roaming, may be mapped before roaming to the 5 GHz link with the original BSS. However, in the roaming target BSS, all TID 7 traffic is mapped to the 6 GHz link (i.e., the roaming target BSS doesn't support 5 GHz link or GHz link is used to serve traffic with other TIDs). In this case, a new design is needed to assist the roaming STA to quickly use the enabled link without renegotiating for TTLM.

2.1.4. Conflicts with Link Number

A roaming non-AP MLD may transit to a new BSS with a different number of links and operating bands from that in the original BSS before roaming. For example, the AP MLD of the original BSS before roaming supports three links including 2.4 GHz, 5 GHz and 6 GHz links and the AP MLD of the roaming target BSS in this example only supports two links including 2.4 GHz and 5 GHz links. In this case, enhancements are necessary in order to process the traffic on 6 GHz links from the original BSS after the roaming STA has moved to the target BSS.

### 2.1.5. Conflicts in Capability and Operating Mode

BSSs may operate under different channel access rules e.g., NSTR, STR, EMLSR and EMLMR mode. For example, when the original BSS before roaming supports NSTR over two links including 5 GHz and 6 GHz link and the roaming target BSS supports STR over the same two links, the roaming STA will be subject to channel access limitations during and after it has roamed to the target BSS. In this case, new enhancements are needed to assist the roaming STA to achieve seamless roaming.

### 3. Approach of the Present Disclosure

The present disclosure describes new methods and designs for reducing link management negotiation procedures toward improving seamless roaming for a roaming non-AP MLD. In this context, key enhancements can include the following. (a) A new Global Link ID is designed to identify a link based on a new UHR architecture with backhaul connection as shown and described in the following Section. (b) A new Global AID Bitmap element is designed to identify the non-AP MLDs for which a link recommendation is provided based on a new UHR architecture with backhaul connection as shown and described in the following Section. (c) A new Partial Virtual bitmap in the TIM element is designed to adapt to use Global AID in traffic indication. (d) A new Global Multi-Link Traffic Indication element is designed to contain a list of per-link traffic indication bitmap(s) corresponding to the Global Link ID and Global AID for non-AP MLDs. (e) A new Multi-Link element is described for carrying Enhanced Multi-Link (EML) and MLD Capabilities and Operations for multiple AP MLDs that are connected to the same central controller. (f) Use of link management related functionalities which are based on the new UHR architecture.

### 4. Hardware Embodiments

### 4.1. Communication Station (STA and MLD) Hardware

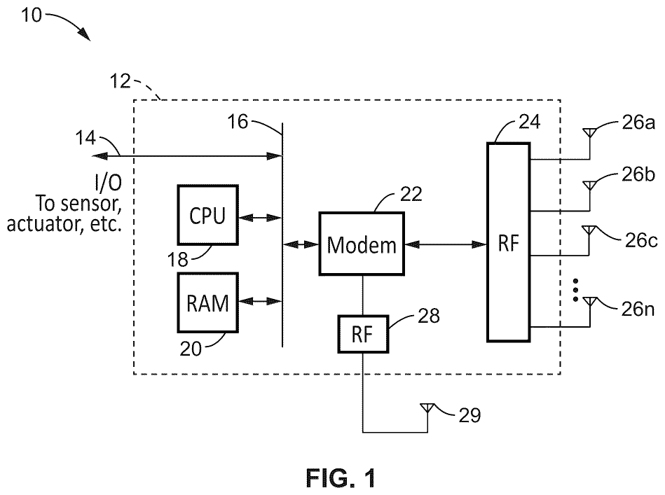

FIG. 1 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows for performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

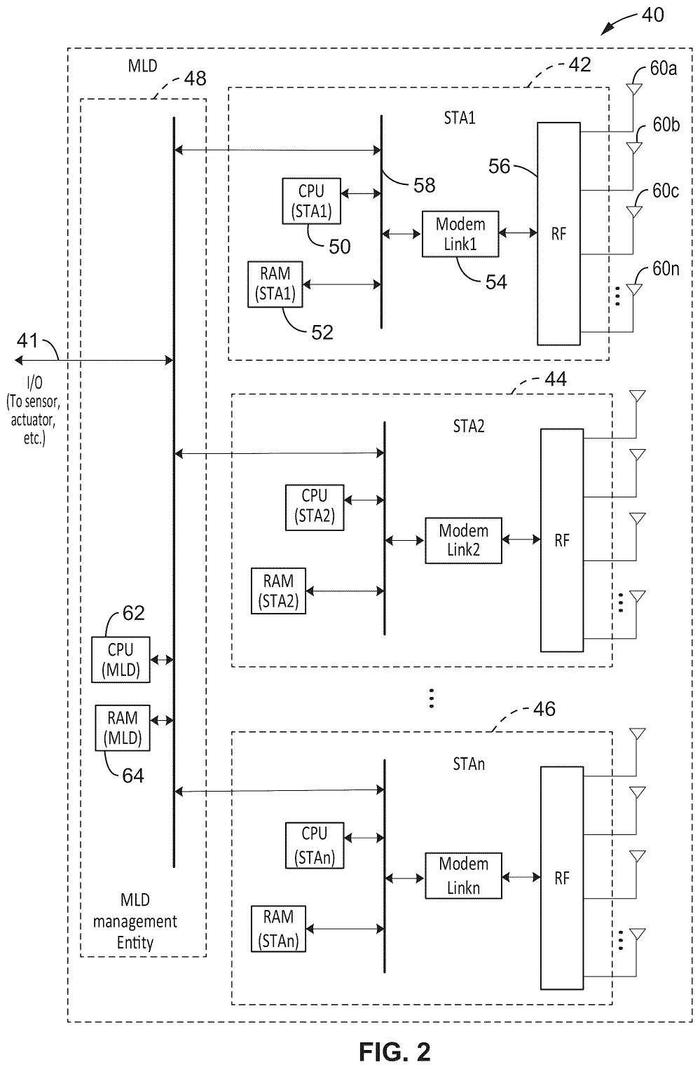

FIG. 2 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHz), basic link set (2.4 GHz and 6 GHz).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

4.2. Central Controller with Multiple MLDs

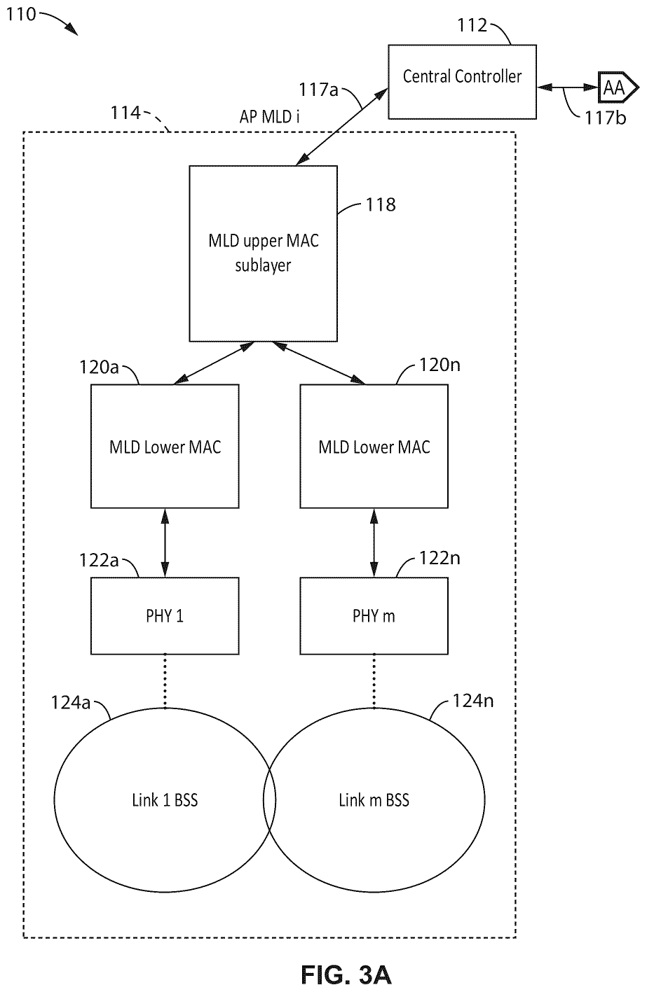

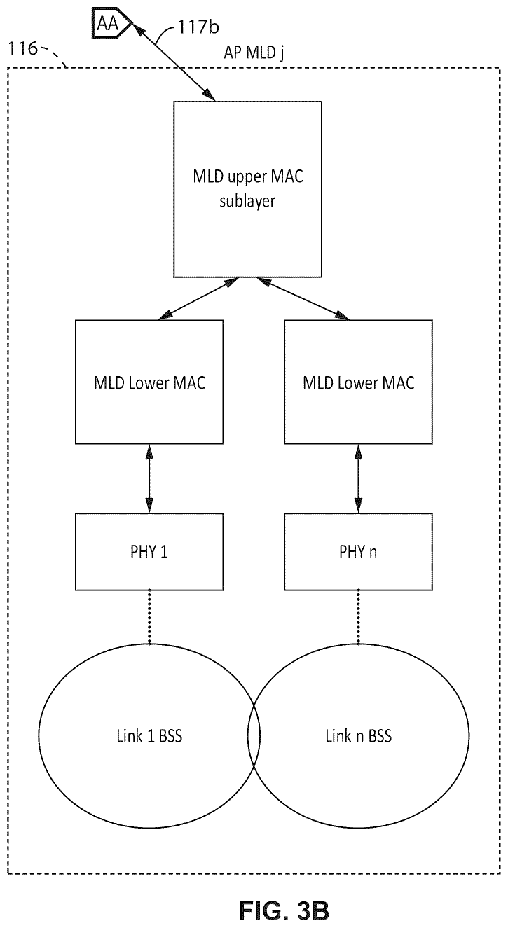

FIG. 3A and FIG. 3B illustrates an example embodiment 110 of a central controller architecture, in which a central controller 112 is connected with multiple AP MLDs 114, 116 through wired and/or wireless backhauls 117a, 117b. Each AP MLD includes the MLD upper MAC sublayer 118, and one or more MLD lower MAC sublayers 120a through to 120n (one for each link), over respective Physical (PHY) layers 122a through to 122n, that are connected to Link 1 BSS 124a through to Link m BSS, and through to Link n BSS 124n, in FIG. 3A and FIG. 3B, respectively.

In the 802.11 be specification, the MLD upper MAC sublayer performs functionalities that are common across all links, and each MLD lower MAC sublayer performs functionalities that are local to each link. For example, certain link management related functionalities, such as TID-to-Link mapping and Link Merging, are placed in the MLD upper MAC sublayer. In 802.11 bn, certain functionalities originally in the MLD upper MAC sublayer as specified in 802.11 be are suitable for being placed in the central controller toward enabling a higher level of seamless roaming with limited or no interruptions of service. The present disclosure considers link management functionalities placed in the central controller or/and the MLD upper MAC sublayers. The corresponding design is then described and disclosed in following sections.

### 5. Enhancements to Mitigate the Link ID Conflicts

In IEEE P802.11 be, during ML discovery, ML (re)setup and ML reconfiguration stages, the Link ID information is carried in a different variant of the Multi-Link element, such as in a Basic Multi-Link element, Probe Request Multi-Link element, Reconfiguration Multi-Link element, or other element as appropriate.

To resolve the link ID conflict issue, the different variants of Multi-Link element carrying the Global Link ID can be configured. The location of the new Global Link ID Indication field(s)/subfield(s) can be placed in fields of different variants of Multi-Link element or in the subfields (at any level) of different variants of the Multi-Link elements and may or may not replace the current Link ID. The interpretation of the Global Link ID Indication field(s) or subfield(s) should include, but not be limited to multiple functions such as: (a) indicating the Supporting Capability of the Global Link ID; (b) indicating the presence of the Global Link Info field; and/or (c) indicating the Global Link Info field as defined in the following sections.

The AP MLD that is connected with a central controller can support the use of both Global Link ID for global operation among multiple BSSs, which are managed by multiple AP MLD(s) that are connected with the same central controller, and Local Link ID, which is the same as the Link ID defined in IEEE P802.11 be to be backward compatible with pre-UHR devices.

### 6.1. Global Link ID Indicated by Standalone ID

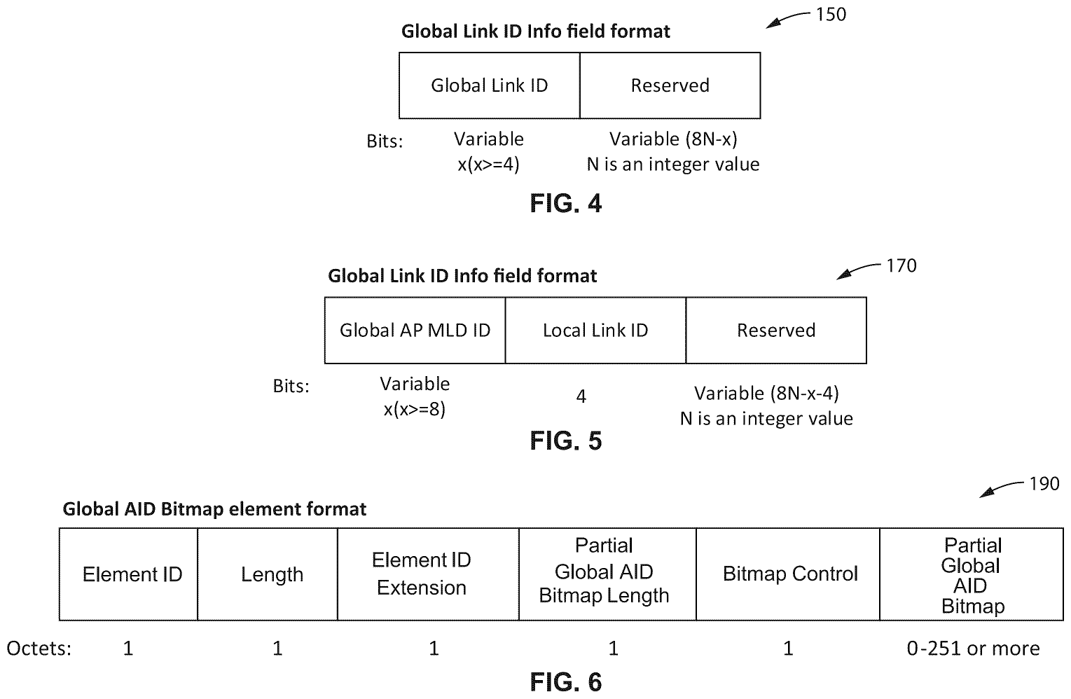

FIG. 4 illustrates an example embodiment 150 of a Global Link ID Information field. In one embodiment, the central controller is enabled to assign a unique Global Link ID to each AP affiliated with an AP MLD that is connecting with the central controller, so that no two affiliated APs of the same AP MLD or of different AP MLDs shall operate on the links with the same Global Link ID. To achieve this, the maximum integer for link ID assignment is expanded from 14 to a larger value. It should be noted that in the 802.11 be specification, a link ID is specified as an integer value between 0-14. The Global Link ID subfield of the Link ID Info field indicates the global identifier of the link.

### 6.2. Global Link ID as Combination of Global AP MLD ID and Link ID

In one embodiment, the central controller is enabled to assign a specific ID, e.g., AP MLD ID, to identify each connected AP MLD and use this specific ID together with the local link ID as specified by AP MLD as the Global Link ID of that link.

FIG. 5 illustrates an example embodiment 170 of the corresponding Global Link ID Info field format of FIG. 4. The Global AP MLD ID subfield indicates the AP MLD ID assigned by the central controller. Each AP MLD connecting with the central controller should have a unique Global AP MLD ID. In the IEEE P802.11 be specification, the AP MLD ID field is 8 bits in length. In at least one option for this disclosure, the Global AP MLD ID field may be configured to have a number of bits equal to or larger than 8 bits in length.

The Local Link ID subfield indicates the identifier of the local link as managed by the AP MLD and as indicated by the Global AP MLD ID.

For example, the link m as shown in FIG. 3 is a link identified with local link ID. In order to identify that link with a Global Link ID, the central controller assigns the AP MLD i with an ID: i. The Global Link ID of that link will be a combination of i and m.

### 6.3. Functionality Location

In at least one embodiment of this disclosure, the relevant functionalities of the Global Link ID as defined in Section 6.1 is located in the central controller. In at least one other embodiment, the relevant functionalities of the Global Link ID as defined in Section 6.2 is located in either the MLD upper MAC sublayer or across the central controller (for Global AP MLD ID) and the MLD upper MAC sublayer (Local Link ID).

### 7. Enhancements for Mitigating AID Conflicts

The AID is assigned by an AP or an AP MLD during association of a STA or a non-AP MLD. To resolve the AID conflict issue, the present disclosure describes the following differing solutions.

7.1. Request Global AID Directly from Central Controller

In at least one embodiment, the non-AP MLD/STA associates with the central controller from which it obtains the unique Global AID that is understandable by all APs or AP MLDs that connected with the central controller.

7.2. Request Global AID through Associated AP MLD/AP

In at least one embodiment, the non-AP MLD/STA associates with the AP MLD/AP to obtain a local AID. Under this option, the associated AP MLD/AP requires a Global AID for the associated non-AP MLD/STA from its connected central controller. Furthermore, the central controller checks if it has previously assigned a Global AID to the non-AP MLD/STA, such as by recording and checking the MAC address of the non-AP MLD/STA. If the MAC address of the non-AP MLD/STA is new, the central controller should record the non-AP MLD/STA's MAC address for future identification and then pass a new Global AID to the requesting AP MLD/AP. Otherwise, if the non-AP MLD/STA has assigned a Global AID, the central controller should pass the assigned Global AID to the requesting AP MLD/AP. The requesting AP MLD/AP should pass the received Global AID to the non-AP MLD/STA if it's a new Global AID. The requesting AP MLD/AP may or may not pass the received Global AID to the non-AP MLD/STA if it's not a new Global AID. The Global AID can be indicated in a new Global AID Bitmap element as described in the next section.

### 7.3. Global AID Bitmap Element Design

FIG. 6 illustrates an example embodiment 190 of the structure of a Global AID Bitmap element configured to identify the non-AP MLDs for which a link recommendation is provided. The Global AID Bitmap element is carried in a frame transmitted by the AP, or an AP affiliating with the AP MLD connected with the central controller, through the backhaul or by the central controller. The format of this element is shown having the following fields: Element ID, Length, Element ID extension, Partial Global AID bitmap length, Bitmap control, and Partial Global AID bitmap.

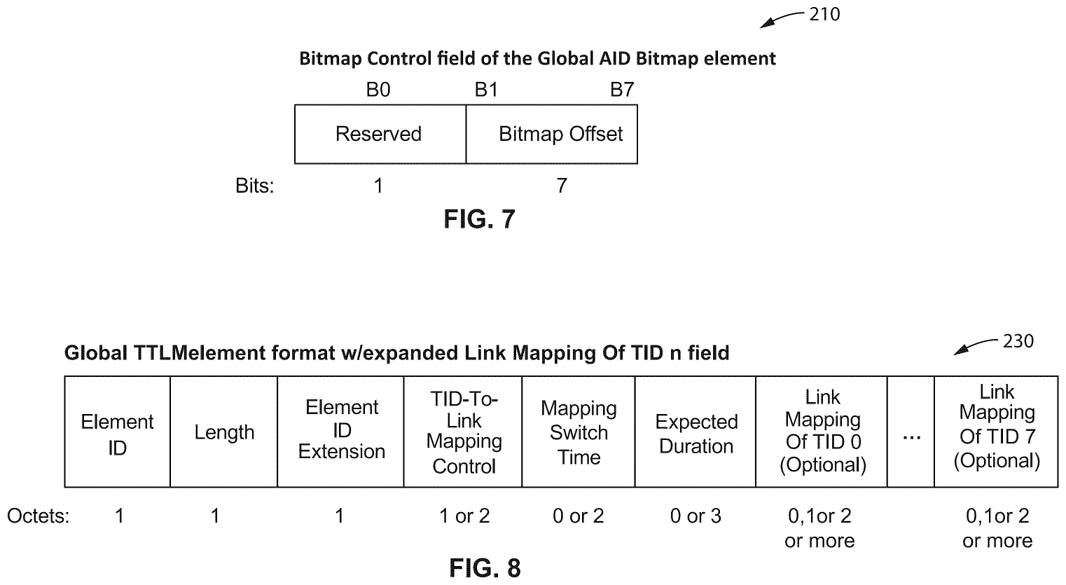

FIG. 7 illustrates an example embodiment 210 of a Partial Global AID Bitmap Length field carrying the length of the Partial Global AID Bitmap field. In this example, the Bitmap Offset subfield is a bitmap index and is used in the definition of the Partial Global AID Bitmap field.

A Global AID bitmap refers to a bitmap consisting of 2008 (as specified in IEEE 802.11 be specification) or more bits, depending on the maximum value of the Partial Global AID Bitmap field in the Global AID Bitmap element, where a bit position N is set to 1 if Global AID N is a member of the signaled list of Global AIDs and otherwise, it is set to 0.

The Partial Global AID Bitmap field consists of octets numbered N1 to N2 of the Global AID bitmap, where N1 is the largest even number, such that bits numbered 1 to (N1*8)−1 in the AID bitmap are all 0 and N2 is the smallest number, such that bits numbered (N2+1)*8 to the maximum bit number N in the AID bitmap are all 0.

### 7.4. Functionality Location

In one embodiment, the relevant functionalities of the Global AID as defined in Section 7.1 should be in the central controller. In another embodiment, the relevant functionalities of the Global AID as defined in Section 7.2 should be in either the central controller or the MLD upper MAC sublayer.

### 8. Global TID-To-Link Mapping (TTLM)

The Non-AP MLD negotiates a global TTLM with the central controller directly, or through the associated AP MLD, the TID-To-Link Mapping is negotiated in the associated BSS and can be applied to other BSSs that have their APs connecting with the same central controller and can support the same link configuration as the one based on the TID-To-Link mapping negotiated in the associated BSS.

If the other BSSs that have their APs connecting with the same central controller don't have the same link configuration as the one in the associated BSS, then the central controller can additionally include the Link Mapping of TID n to a set of link(s), which is identified by Global Link ID. To support the new Global TTLM, the TTLM should be negotiated based on the Global Link ID and the Global AID.

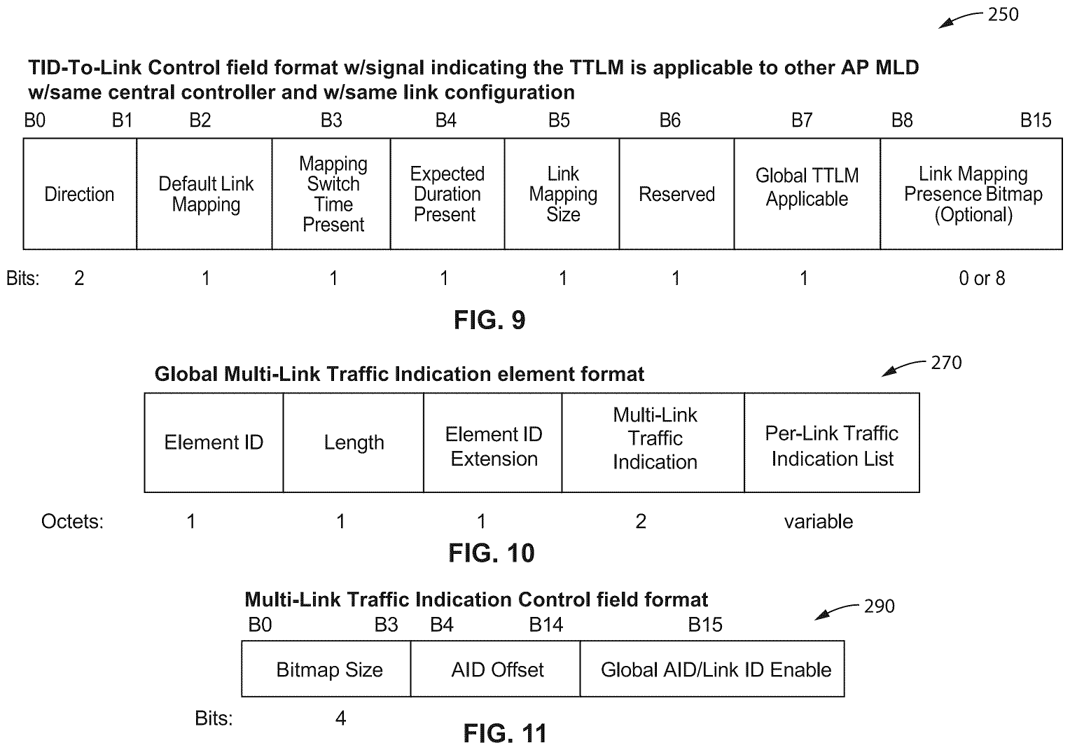

FIG. 8 and FIG. 9 illustrates an example embodiment 230, 250 of a newly designed Global TTLM element (FIG. 8) and the TID-To-Link Control field format (FIG. 9). In this example, a new Global TTLM Applicable subfield uses 1 bit from the reserved bits in the TID-To-Link Control field to indicate whether to enable the global TTLM capability or not. The global TTLM is enabled by setting the Global TTLM Applicable bit to a first state (e.g., “1”), otherwise, it is set to a second state (e.g., “0”).

The Link Mapping of TID n field (where n=0, 1, . . . , 7) in the Global TTLM element indicates on which link(s), that are identified by the Global Link ID, frames belonging to TID n are allowed to be sent. A first value (e.g., “1”) in bit position i of the Link Mapping of TID n field indicates that TID n is mapped to the link associated with the Global Link ID i for the direction as specified in the Direction subfield. A second value (e.g., “0”) in bit position i indicates that the TID n is not mapped to the link associated with the Global Link ID I for the direction as specified in the Direction subfield. When the Default Mapping subfield is set to a first state (e.g., “1”), no Link Mapping of TID n field is present. The Link Mapping of TID n field can have more Octets than two toward fitting the Global Link ID length, the setting of the Link Mapping Size subfield should be adapted to the length of the Link Mapping of TID n field.

If a default link mapping is applied in the current associated BSS, and the Global TTLM Applicable subfield is set to a first state (e.g., “1”), the default link mapping can also be applied in other BSSs without further negotiation.

If a non-AP MLD/STA is roaming to a targeted BSS, the roaming non-AP MLD may still need to apply a default TID-to-Link mapping or renegotiate the TID-to-Link mapping if it doesn't have the Global TTLM information for the roam to the targeted BSS, or if the targeted BSS for roaming doesn't support Global TTLM.

### 8.1. Functionality Location

In one embodiment, the relevant functionalities of the Global TTLM as defined in this section should be in either the central controller or the MLD upper MAC sublayer.

### 9. Link Recommendation w/Global AID Bitmap and Global Link ID

In addition to following the TTLM and/or Global TTLM rules as defined in the previous section, an AP affiliated with an AP MLD may schedule for transmitting a Link Recommendation frame to provide a link recommendation for a set of non-AP MLDs to exchange frames both in DL and UL on enabled links.

The Link Recommendation frame is an Action No Ack frame. The Action field of a Link Recommendation frame contains information on the AID Bitmap element and the Multi-Link Traffic Indication element. In order to apply a Global AID Bitmap element and Global Link ID in the Link Recommendation frame to be used based on the new UHR architecture with a backhaul connection, at least one embodiment is configured with enhancements incorporated for the following elements. (a) In at least one embodiment the Partial Virtual bitmap in TIM element is configured to adapt to using the Global AID for traffic indication. (b) In at least one embodiment a new Global Multi-Link Traffic Indication element is configured as in Section 9.1 to contain a list of per-link traffic indication bitmap(s) corresponding to the Global Link ID and Global AID for non-AP MLDs.

If the AP/AP MLD or the central controller intends to provide link recommendation for this non-AP MLD in one or more BSSs, where the corresponding APs are connected to the central controller, with or without affiliating with the AP MLDs, the bit corresponding to the Global AID of a non-AP MLD shall be set to a first state (e.g., “1”) in the Partial Global AID Bitmap subfield of the Global AID Bitmap element in the Link Recommendation frame.

9.1. Global Multi-Link Traffic Indication with Global AID and Link ID

FIG. 10 illustrates an example embodiment 270 of a Global Multi-Link Traffic Indication element which contains a list of per-link traffic indication bitmap(s) corresponding to the Global link ID and Global AID for non-AP MLD(s). The Global Multi-Link Traffic Indication element has the following fields: Element ID, Length, Element ID extension, Multi-Link Traffic Indication Control, and Per-Link Traffic Indication list.

FIG. 11 illustrates an example embodiment 290 of a Multi-Link Traffic Indication Control field. It should be noted that the Bitmap Size subfield and the AID Offset subfield may be identical to that in the Multi-Link Traffic Indication Control field of the Multi-Link Traffic Indication element defined in the IEEE 802.11 be specification. However, a new subfield named Global AID/Link ID Enable has been configured, such as using reserved bit B15 in the IEEE 802.11 be specification. A first state (e.g., “1”) of this bit in the Global AID/Link ID Enable subfield indicates this element is a Global Multi-Link Traffic Indication element; while when set to a second state (e.g., “0”) this indicates it is a regular Multi-Link Traffic Indication element.

In one embodiment, the Global Multi-Link Traffic Indication element includes Per-Link Traffic Indication Bitmap ‘n’ subfield(s) in the Per-Link Traffic Indication List field, which correspond(s) to the Global AID(s) of the non-AP MLD(s), starting from bit number ‘k’ of the Partial Global AID Bitmap subfield of the Global AID Bitmap element carried in the Link Recommendation frame. The AID Offset subfield of the Multi-Link Traffic Indication Control field of the Multi-Link Traffic Indication element contains the value ‘k’. The order of the Per-Link Traffic Indication Bitmap ‘n’ subfield(s) follows the order of the bits that are set to a first state (e.g., “1”) in the Partial Global AID Bitmap subfield of the Global AID Bitmap element carried in the Link Recommendation frame that corresponds to the Global AID(s) of the non-AP MLD(s). The bit position ‘i’ of the Per-Link Traffic Indication Bitmap ‘n’ subfield in the Multi-Link Traffic Indication element that corresponds to the link with the Global Link ID subfield equal to ‘i’ on which a non-AP STA affiliated with the non-AP MLD is operating shall be set to a first state (e.g., “1”) to indicate to the non-AP MLD that it should exchange frames on this link both in DL and UL, while following the TTLM rules or Global TTLM rules as defined in this disclosure.

In at least one embodiment, the Per-Link Traffic Indication List field and the Per-Link Traffic Indication Bitmap ‘n’ subfield can be defined the same as that of the IEEE 802.11 be specification, expecting that the AID and Link ID refer to the Global AID and Global Link ID, respectively. More Global Multi-Link Traffic Indication element configuration examples are described below.

9.2. Traffic Negotiation with Global link ID Identified by Single Integer

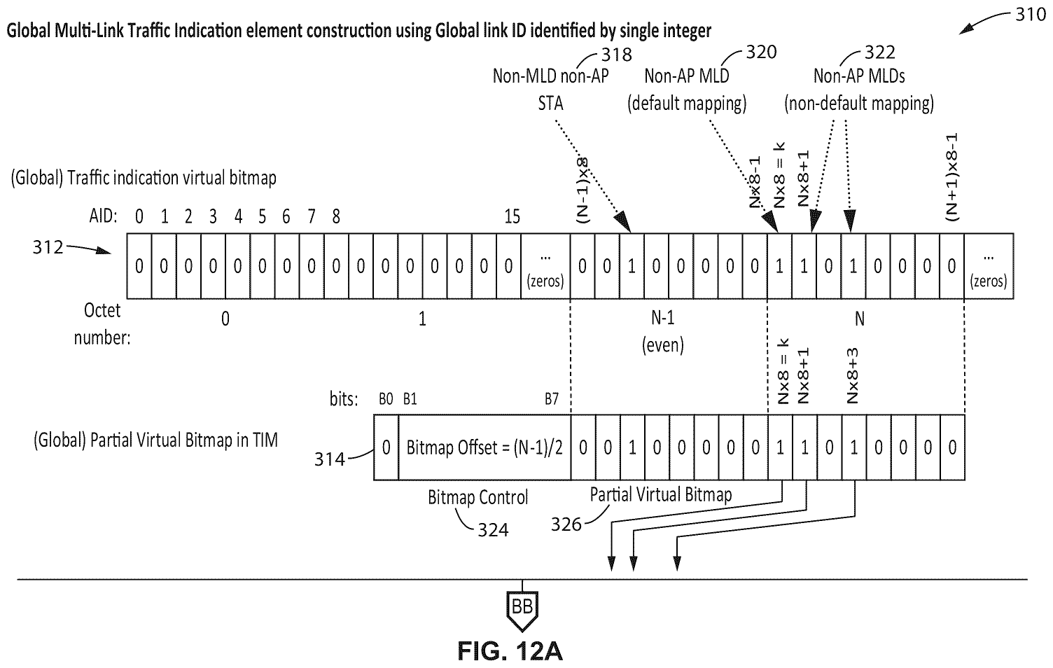

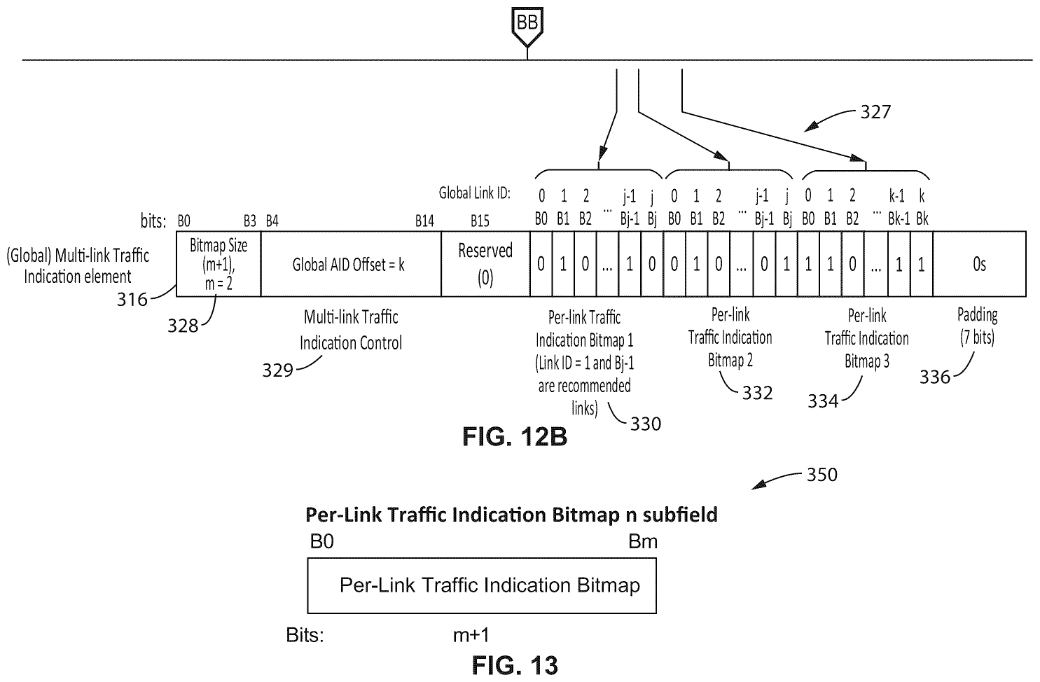

FIG. 12A and FIG. 12B illustrate an example embodiment 310 of the Global Multi-Link Traffic Indication element construction, showing sections as (Global/non-Global), Traffic Indication Virtual Bitmap 312, (Global/non-Global) Partial Virtual Bitmap in TIM 314, and (Global/non-Global) Multi-link Traffic indication element 316. On the top line 312 of the example figure, bits are seen for the non-MLD non-AP STA 318, non-AP MLD as default mapping 320, and non-AP MLD as non-default mapping 322. The middle line 314 of the figure shows sections of bitmap control 324 and Partial Virtual Bitmap 326, and per-link traffic indications 327. The lower line 316 of the figure shows sections of Bitmap size 328, Multi-link Traffic Indication Control 329, a reserved field, and Per-link Traffic Indication Bitmap 1 (Link ID=1 and Bⱼ-1 are recommended links) 330, Per-link Traffic Indication Bitmap 2 332, Per-link Traffic Indication Bitmap 3 334, and Padding 336.

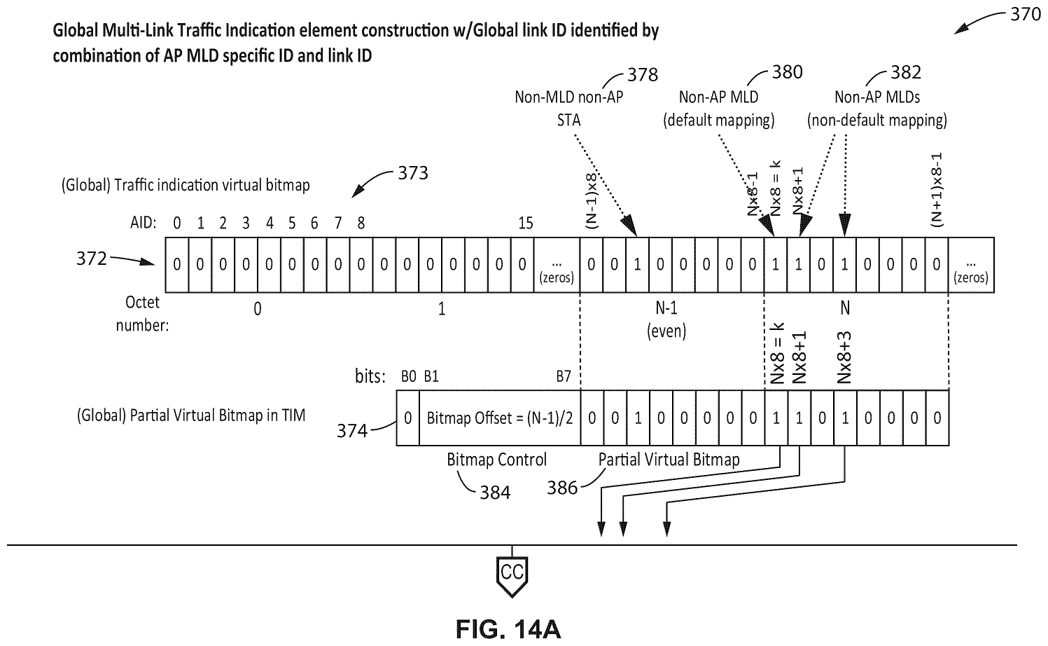

FIG. 13 illustrates an example embodiment 350 a Per-Link Traffic Indication Bitmap ‘n’ subfield in which each bit corresponds to a link and the bit position ‘i’ of the bitmap, Bᵢ, corresponds to a link with Global Link ID subfield equal to i. A bit position that corresponds to a link that is not a setup link is reserved.

### 9.3. Traffic Negotiation Using Global Link ID Identified by a Combination of AP MLD Specific ID and Link ID

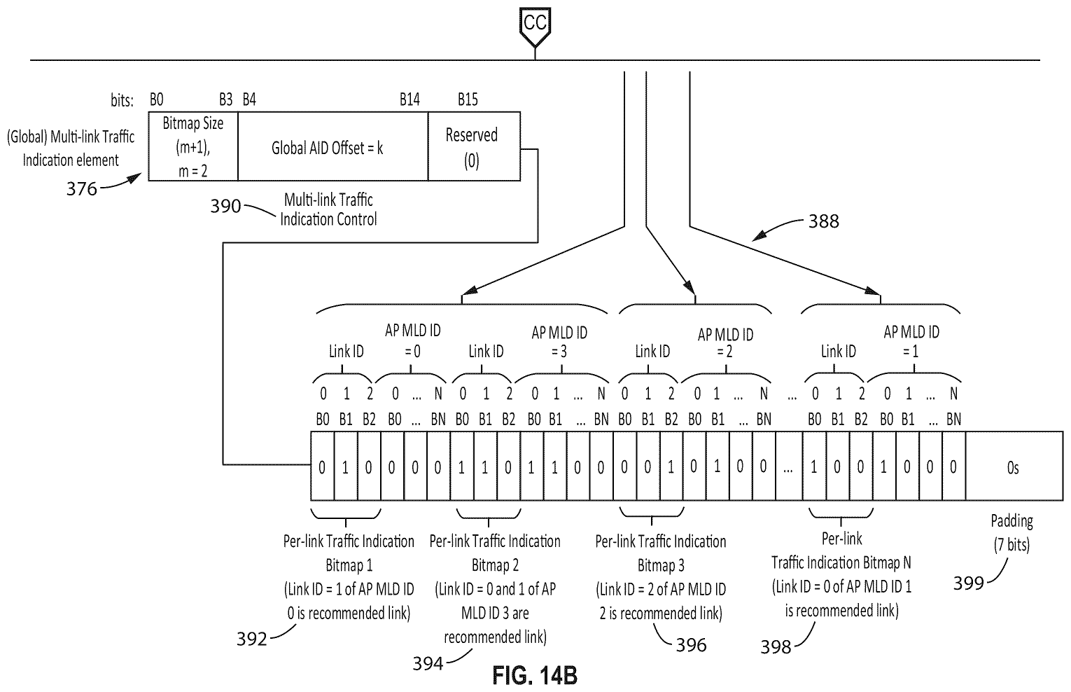

FIG. 14A and FIG. 14B illustrates an example embodiment 370 of a Global Central Controller Connected Multi-Link Traffic Indication element showing sections as (Global/non-Global), Traffic Indication Virtual Bitmap 372, (Global/non-Global) Partial Virtual Bitmap in TIM 374, and (Global/non-Global) Multi-link Traffic indication element 376.

On the top line 372 of the example figure is an AID section 373, and further along are bits seen for the non-MLD non-AP STA 378, non-AP MLD as default mapping 380, and non-AP MLDs in a non-default mapping 382. The middle line 374 of the figure shows sections of bitmap control 384, Partial Virtual Bitmap 386, and per-link traffic control 388. The lower line 376 of the figure shows sections of Multi-link Traffic Indication Control 390, Per-link Traffic Indication Bitmap 1 392 (Link ID=1 of AP MLD ID in which ‘0’ is the recommended link), Per-link Traffic Indication Bitmap 2 394 (Link ID=0 and 1 with AP MLD ID 3 being the recommended link), and Per-link Traffic Indication Bitmap 3 (Link ID=2 of AP MLD ID 2 as the recommended link), and down to Per-link Traffic Indication Bitmap ‘N’ 398 (Link ID=0 with AP MLD ID 1 being the recommended link), and followed by padding 399.

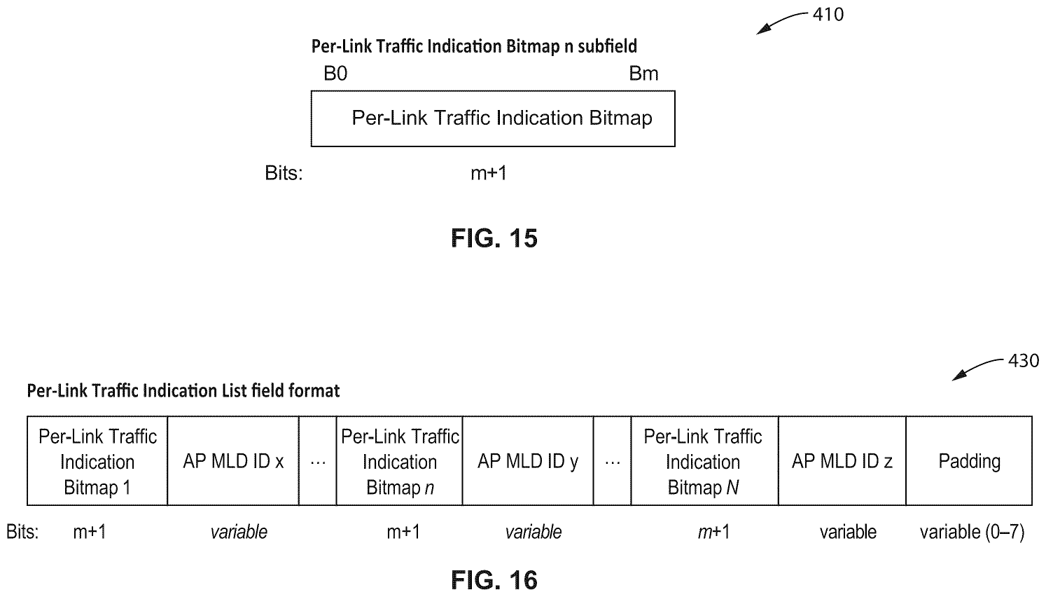

FIG. 15 illustrates an example embodiment 410 of the corresponding Per-Link Traffic Indication Bitmap ‘n’ subfields, whose subfields are shown in FIG. 16. In at least one option, each bit in the Per-Link Traffic Indication Bitmap ‘n’ subfield corresponds to a link and the bit position ‘i’ of the bitmap, Bᵢ, corresponds to a link with (Local) Link ID subfield equal to ‘i’. A bit position that corresponds to a link that is not a setup link is reserved.

In one option, a new subfield of the AP MLD ID is included inside Per-Link Traffic Indication List field in this case to indicate the Global link ID by both the Per-Link Traffic Indication Bitmap, which is a local Link ID Bitmap, and the AP MLD ID. For example, this can be done as was shown in FIG. 14 where the AP MLD broadcasts the ML traffic indication information for multiple non-AP MLDs. In at least one embodiment or option, the non-AP MLD is identified by the Global AID ‘k’, the AP MLD recommends the link that is identified by (local) Link ID 1 of the BSS that is identified by AP MLD ID 0 and the links that are identified by (local) Link ID 0 and 1 of the BSSs that are identified by AP MLD ID 3 as the recommended links. For the non-AP MLD identified by the Global AID ‘k+1’, AP MLD recommends the link that is identified by (local) Link ID 2 of the BSS that is identified by AP MLD ID 2, For the non-AP MLD identified by the Global AID ‘k+3’, the AP MLD recommends the link that is identified by (local) Link ID 0 of the BSS that is identified by AP MLD ID 1.

FIG. 16 illustrates an example embodiment 430 of the Per-Link traffic indication List field format, showing subfields of Per-Link Traffic Indication Bitmap 1 in having bits ‘m+1’, then an AP MLD ID ‘x’ subfield having a variable number of bits, and similar groups of information for Bitmap ‘n’ and AP MLD ID ‘y’, and Bitmap ‘N’ and AP MLD ID ‘z’, followed by padding.

### 9.4. Functionality Location

In at least one embodiment, the relevant functionalities of the Global Multi-Link Traffic Indication as defined in Section 9.2 may be performed in the central controller.

In at least one embodiment, the relevant functionalities of the Global Multi-Link Traffic Indication as defined in Section 9.3 may be performed in either the central controller or the MLD upper MAC sublayer or across the central controller (for AP MLD ID) and the MLD upper MAC sublayer (for Per-Link Traffic Indication).

### 10. Enhancements for Operation Mode Conflict Resolution

In the IEEE P802.11 be specification, the EML Capabilities and (Extended) MLD Capabilities are carried in the Common Info field of the Basic Multi-Link element. The EML Capabilities subfield contains a number of subfields that are used to advertise the capabilities for Enhanced Multi-Link Single-Radio (EMLSR) operation and Enhanced Multi-Link Multi-Radio (EMLMR) operation. The MLD Capabilities and Operations subfields indicates the MLD's capabilities, such as Maximum Number Of Simultaneous Links, Single-Response Scheduling (SRS) Support, TID-To-Link Mapping (TTLM) Negotiation Support, Frequency Separation for STR/AP MLD Type Indication, AP Assistance Request (AAR) Support, Link Reconfiguration Operation Support, and Aligned TWT Support. The Extended MLD Capabilities And Operations subfields indicate the Operation Parameter Update Support, Recommended Max Simultaneous Links and NSTR Status Update Support. The Link Information field of the Multi-Link element carries one or more Per-STA Profile subelements that indicate STA MAC Address, Beacon Interval, TSF Offset, Delivery Traffic Indication Map (DTIM) Information, NSTR Indication Bitmap and BSS Parameters Change Count.

The capabilities and supported operation mode of the MLD, such as STR, NSTR, EMLSR and EMLMR are specified by the common Information field and the Link Information field of the Basic Multi-Link element that are negotiated between a non-AP MLD and an AP MLD, which is identified by the AP MLD ID in the Common Information field of the Basic Multi-Link element.

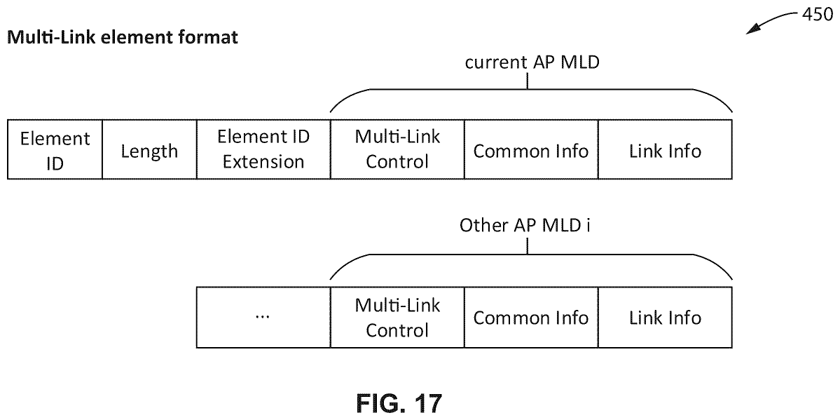

FIG. 17 illustrates an example embodiment 450 of a new Multi-Link element format. In order to carry the other AP MLD's Capabilities and Supported operation information in the same Multi-Link element, the present disclosure extends the Multi-Link Control field, the Common Info field and the Link Info field of the other AP MLD after these fields corresponding to the current AP MLD with whom the non-AP MLD negotiates with. It can be seen in the upper line of FIG. 17 the frame fields of Element ID, Length and element ID extension, followed by fields for one MLD with a Multi-Link Control subfield, a Common Information subfield and a Link Information subfield. This group of subfields is then present for the other AP MLDs as exemplified by the lower line of the figure for AP MLD ‘i’.

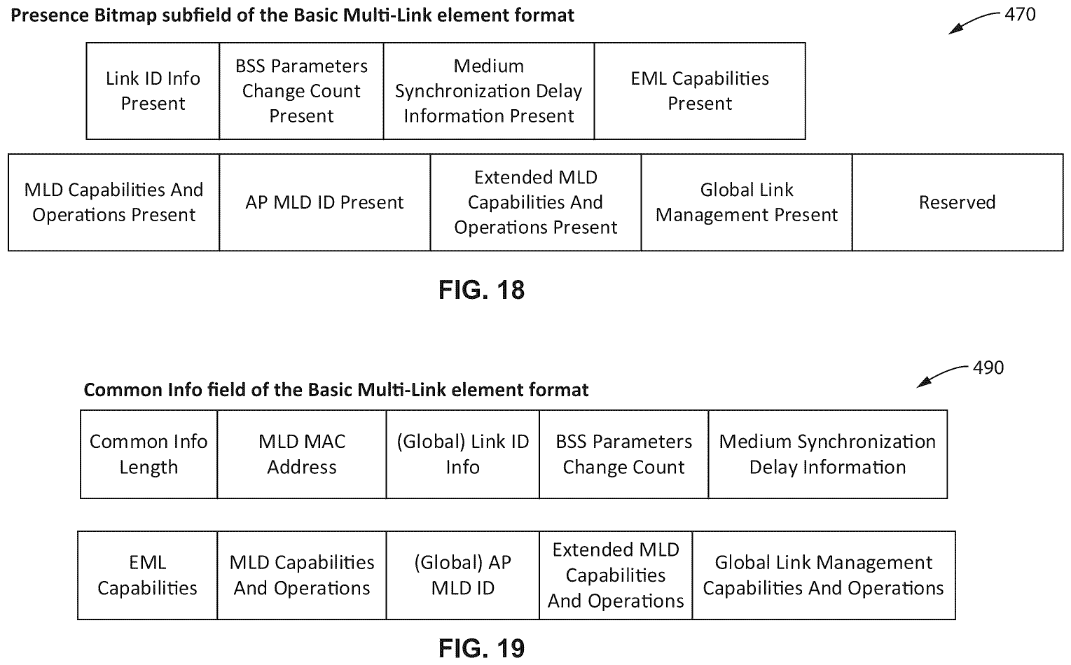

FIG. 18 illustrates an example embodiment 470 of a Presence Bitmap subfield of the Basic Multi-Link element. In at least one embodiment, a Global Link Management Present subfield has been included to indicate whether a Global Link Management Capabilities And Operations subfield is present in the Common Info field of the Basic Multi-Link element as described below for FIG. 19. The Global Link Management Present subfield is set to a first state (e.g., ‘1’) if the Global Link Management Capabilities And Operations Subfield is present in the Common field. Otherwise, the Global Link Management Present subfield is set to a second state (e.g., ‘0’). The remainer of the Presence Bitmap subfields of the Basic Multi-Link element are the same as that in IEEE P802.11 be specification, and are shown here with subfields of Link ID Info Present, BSS Parameters Change Count Present, Medium Synchronization Delay Information Present, EML Capabilities Present, MLD Capabilities And Operations Present, MLD ID Present, Extended MLD Capabilities And Operations Present, with a Reserved bit area.

FIG. 19 illustrates an example embodiment 490 of a new common Information field of the Basic Multi-Link element. If the Global Link Management Present subfield of the Presence Bitmap subfield of the Basic Multi-Link element as seen in FIG. 18 is set to a first state (e.g., “1”), the Link ID Info subfield and the AP MLD ID subfield in the Common Info field of the Basic Multi-Link element refer to a Global Link ID and a Global AP MLD ID, respectively. The AP MLD ID subfield indicates the identifier of the AP MLD whose MLD information is carried in the Basic Multi-Link element.

Aside from that, the Global Link Management Capabilities And Operations subfield is present to provide further indication if conflicts can occur when switching from one AP MLD's operation mode to another operating mode of the AP MLD. The remainer of the Common Info subfields are the same as that in IEEE P802.11 be specification, and are shown here with subfields of Common Information Length, MLD MAC Address, (Global) Link ID Information, BSS Parameters Change Count, Medium Synchronization Delay Information, EML Capabilities, MLS Capabilities And Operations, (Global) AP MLD ID, and Extended MLD Capabilities And Operations subfield.

In at least one embodiment, the relevant functionalities of the capability and operation mode as defined in Section 10 should be in either the central controller or the MLD upper MAC sublayer.

### 11. Example Roaming Operations

### 11.1. Example 1 of Roaming

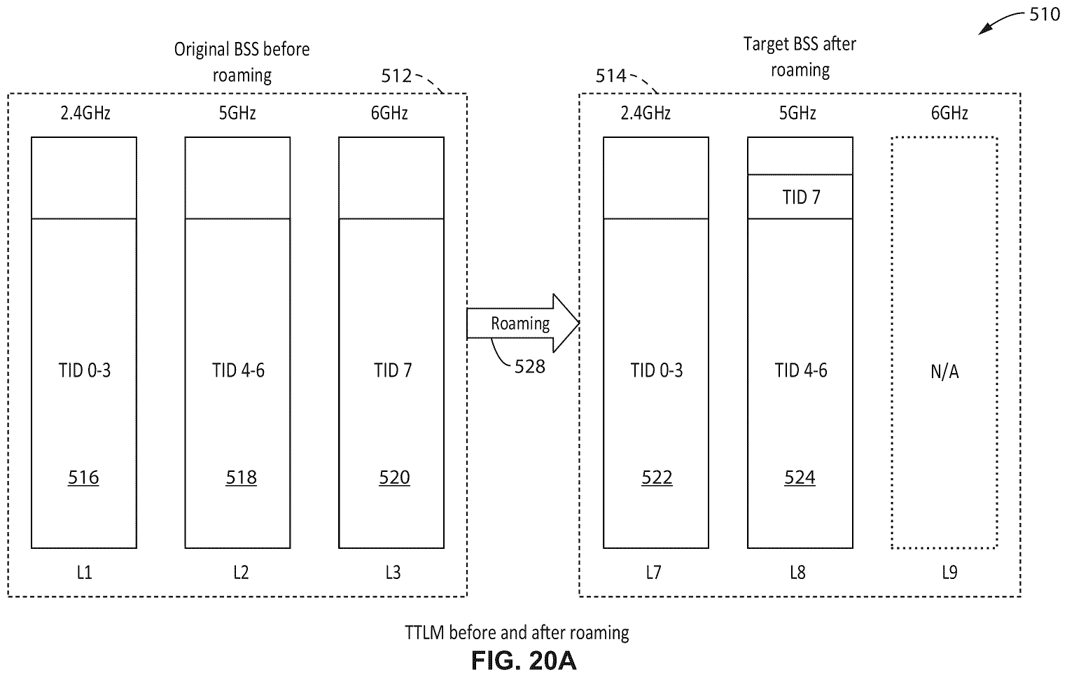

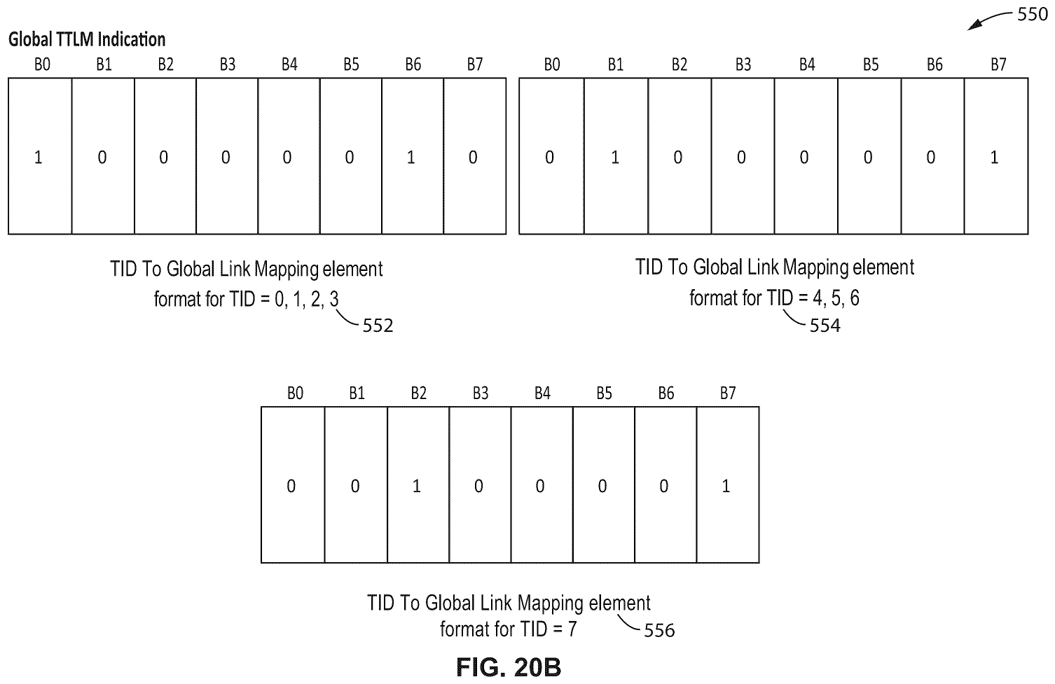

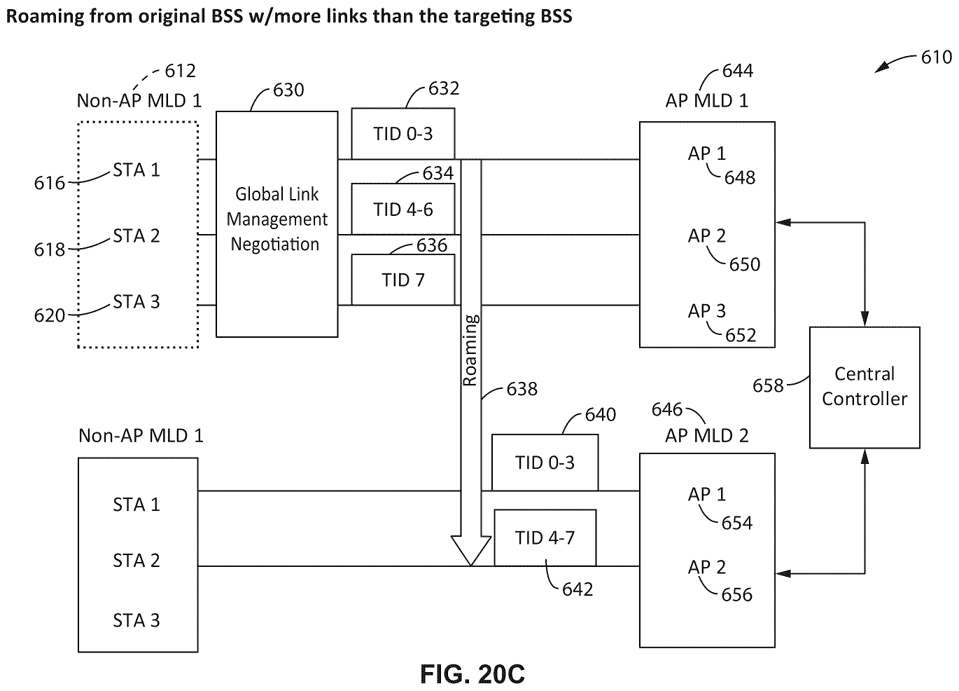

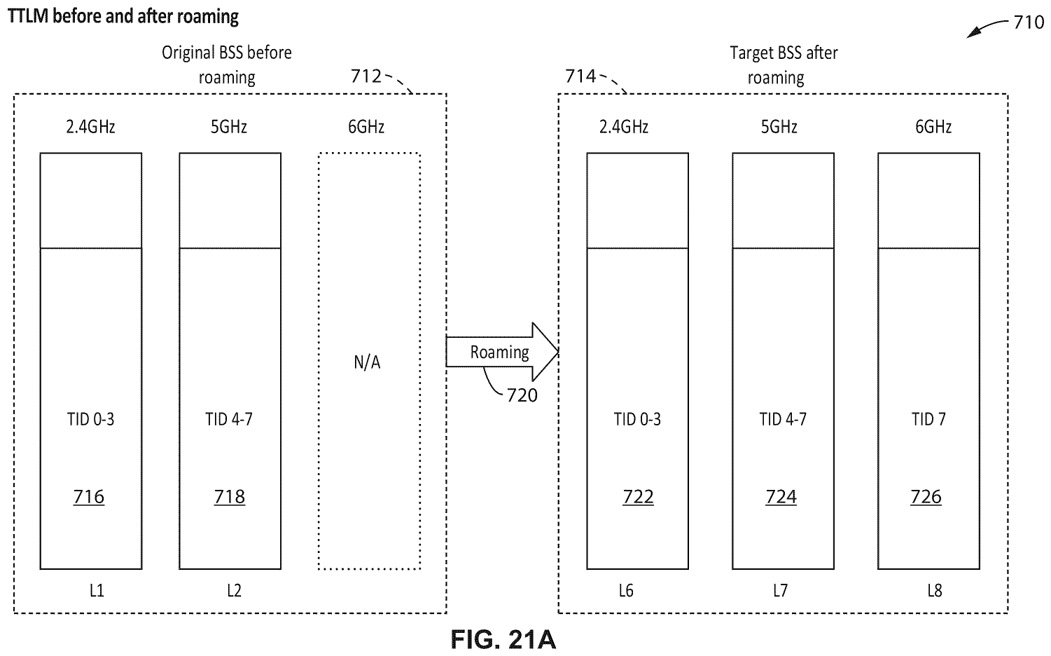

FIG. 20A through FIG. 20C illustrate an example embodiment 510, 550, 570 of roaming from an original BSS with more links than the targeted BSS.

FIG. 20A shows the different link capabilities between an Original BSS before roaming 512, and a Target BSS after roaming 514. The original BSS before roaming supports three links, including 2.4 GHz 516 (TID 0-3), 5 GHz 518 (TID 4-6) and 6 GHz 520 (TID 7) links which are identified by Global Link ID L1, L2 and L3, respectively. The target BSS after roaming 528 supports two links, including 2.4 GHz 522 (TID 0-3) and 5 GHz 524 (TID 4-6) links, which are identified by Global Link ID L7 and L8, respectively. The TTLM negotiated for the original BSS before roaming is to map TID 0-3 to L1, TID 4-6 to L2 and TID 7 to L3. The supported TTLM for the target BSS after roaming would be mapping TID 0-3 to L7, TID 4-7 to L8.

FIG. 20B shows mapping elements in this roaming example. To negotiate the global TTLM so that the roaming non-AP STA doesn't need to renegotiate the TTLM once it roams to the target BSS. The TID To Global Link Mapping element 552, indicates that for TID 0-3, the frames are mapped to links that are identified by Global Link ID 1 and 7 (as seen by the B0=1, and B6=1). For TID To Global Link Mapping element 554, with TIDs 4-6, the frames are mapped to links that are identified by Global Link ID 2 (B1=1) and ID 8 (B7=1). For TID To Global Link Mapping element 556, and its TID 7, the frames are mapped to the link that are identified by Global Link ID 3 (B2=1) and ID 8 (B7=1).

FIG. 20C shows the roaming procedure from Original BSS to the Target BSS. In the upper portion of the figure non-AP MLD 1 612 with STA 1 616, STA 2 618, and STA3 620 is initially communicating with AP MLD 1 644 with AP1 648, AP2 650 and AP3 652, which is connected through a backhaul to Central Controller 658. During this time non-AP MLD 1 roams 638 to then start communicating with AP MLD 2 646 which has stations AP1 654 and AP2 656. AP MLD 2 is also shown connecting through the backhaul to Central Controller 658. The following operations are performed during this process.

Non-AP MLD 1 612 only negotiates 630 one time with AP MLD 1 for global link management. Traffic is shown being communicated to AP MLD 1 644, with TID 0-3 632, TID 4-6 634, and TID 7 636. When the non-AP MLD1 roams 638 to the target BSS managed by AP MLD 2 646, no further link management negotiation is needed. And the transmission of frames with TID 0-3 switch from using L1 to L7; the transmission of frames with TID 4-6 switch from using L2 to L8; and the transmission of frames with TID 7 switch from using L3 to L8. As soon as roaming occurs, then transmissions, such as TID 0-3 640 and TID 4-7 642 may be directed from non-AP MLD 1 STA 1 and STA 2 to AP1 and AP2, respectively, of AP MLD 2 646.

11.2. Roaming from original BSS w/less links than the targeting BSS

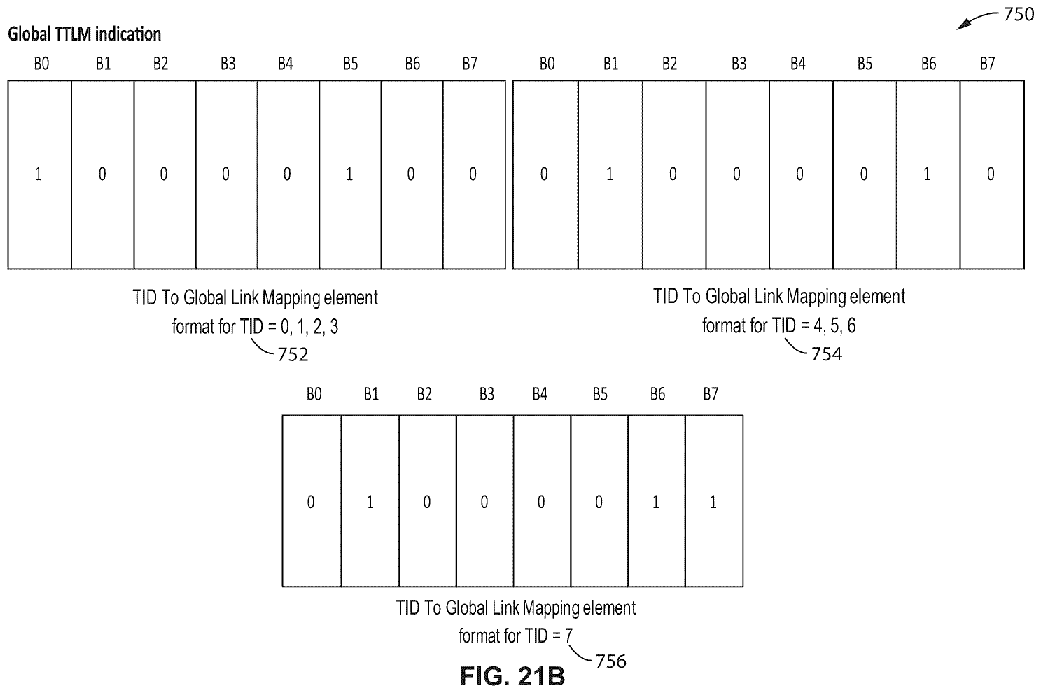

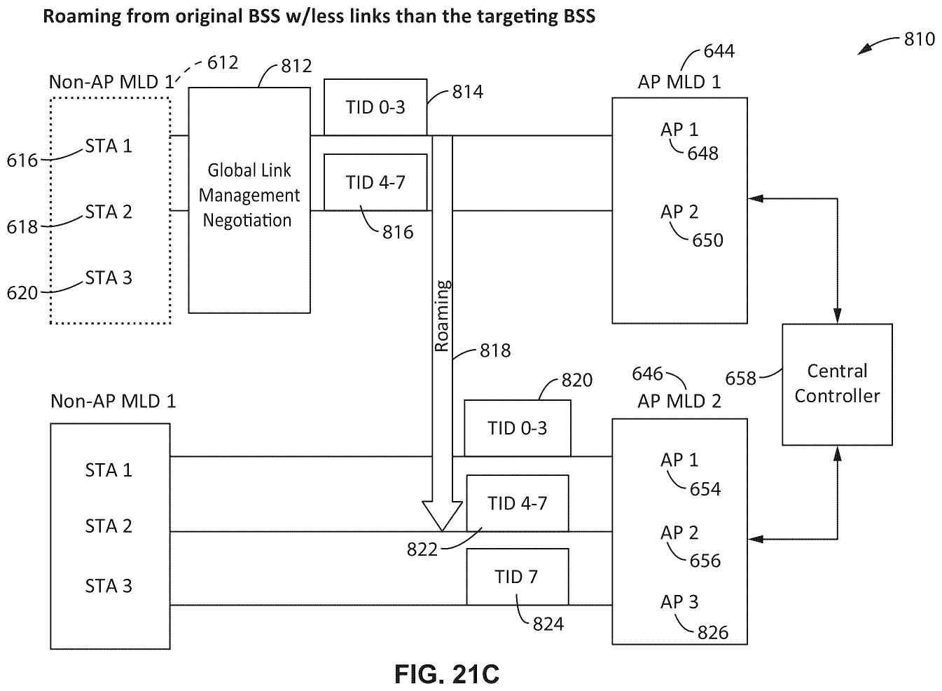

FIG. 21A through FIG. 21C illustrates an example embodiment 710, 750, 810 showing another BSS roaming example on MLDs with differing link capabilities. The example is the converse of that shown in FIG. 20A through FIG. 20C, in that there are more links available in the target MLD than in the originating MLD.

In FIG. 21A the original BSS 712 before roaming supports two links, including 2.4 GHz 716 (TID 0-3) and 5 GHz 718 (TID 4-7) links which are identified by Global Link ID L1 and L2, respectively. The target BSS 714 after roaming 720 supports three links, including 2.4 GHz 722 (TID 0-3), 5 GHz 724 (TID 4-7) and 6 GHz 726 (TID 7), which are identified by Global Link ID L6, L7 and L8, respectively. The TTLM negotiated for the original BSS before roaming is to map TID 0-3 to L1, and TID 4-7 to L2. The supported TTLM for the target BSS after roaming would be mapping TID 0-3 to L6, TID 4-7 to L7 and TD 7 to L8.

Thus, FIG. 21A depicts the stations of non-AP MLD 1 612 negotiating 630 for Global Link Management, performing transmissions of TID 0-3 632, TID 4-6 634 and TID 7 636 to AP MLD 1 644. Then non-AP MLD 1 roams 638 to AP MLD 2, and with the new link mapping non-AP MLD 1 transmits TID 0-3 640 and TID 4-7 642 to AP1 and AP2 of AP MLD 2.

FIG. 21B shows negotiation of the global TTLM so that the roaming non-AP STA doesn't need to renegotiate the TTLM once it roams to the target BSS. The TID To Global Link Mapping element, as shown in the figure indicates that for TID 0-3 752, the frames are mapped to links that are identified by Global Link ID 1 (B0=1) and 6 (B5-1). The TID To Global Link Mapping element for TID 4-6 754 shows the frames mapped to links that are identified by Global Link ID 2 (B1=1) and 7 (B6=1). The TID To Global Link Mapping element for TID 7 shows the frames mapped to the link that is identified by Global Link ID 2 (B1=1), ID 7 (B6=1) and ID 8 (B7=1).

In FIG. 21C non-AP MLD 1 612 only needs to negotiate one time with AP MLD 1 644 for global link management. Non-AP MLD 1 612 is shown having STA1 616, STA2 618, and STA3 620. AP MLD 1 644 is shown having AP1 648 and AP2 650. AP MLD 2 646 is shown having AP1 654, AP2 656 and AP3 826.

In the upper part of the figure non-AP MLD1 612 performs Global Link Management Negotiation 812, and is seen performing transmissions for TID 0-3 814 and TID 4-7 816 to AP MLD 1 644. When the non-AP MLD1 roams 818 to the target BSS that is managed by AP MLD2 646, no further link management negotiation is needed. The transmission of frames with TID 0-3 switch from using L1 to L6; the transmission of frames with TID 4-6 switch from using L2 to L7; and the transmission of frames with TID 7 switch from using L2 to L7 and L8. Thus, non-AP MLD1 612 is seen performing transmissions for TID 0-3 820, TID 4-7 822, and TID 7 824 to AP1 through AP3 on AP MLD2 646.

### 12. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure (s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:
A multiple station apparatus for communication in a wireless network, the apparatus comprising: (a) a multiple link device (MLD) having at least two stations, in which each station has at least one modem coupled to at least one radio-frequency (RF) circuit, with each RF circuit configured for connecting to one or multiple antennas, and wherein said MLD is configured for connecting to a central controller through a backhaul communications connection; (b) a processor of said MLD; (c) a non-transitory memory storing instructions executable by the processor for wirelessly communicating with other stations on a IEEE 802.11 wireless local area network (WLAN); and (d) wherein said instructions, when executed by the processor, perform steps of a wireless communications protocol, comprising: (d)(i) wherein said MLD operates a wireless communications protocol as either an access point (AP) MLD having multiple APs, or as non-AP MLD having multiple stations; (d)(ii) wherein each said MLD is configured to allow roaming from a first basic service set (BSS) and an AP MLD, to which it is associated, to a second BSS of a target AP MLD; (d)(iii) wherein each AP of any AP MLD, and each non-AP station of any MLD, utilizing the wireless communications protocol is configured for directly or indirectly obtaining a global link identification (ID) from the central controller; said global link ID is issued in a manner that no two APs or non-AP stations, of the same or different MLDs, can obtain the same global link ID, and thus no two APs or non-AP stations are allowed to operate on the links with the same global link ID; (d)(iv) wherein said non-AP station requests a global association identification (AID) either directly from the central controller, or from its associated AP, or AP MLP, in which the global AID is understandable by all APs or AP MLDs that are connected with the central controller; (d)(v) wherein when said MLD is operating as a non-AP MLD, it is configured for transmitting and/or receiving traffic in the first BSS, and prior to roaming to a second BSS, the stations of the non-AP MLD perform a global traffic-identifier (TID)-to-link mapping (TTLM) negotiation, using its global AID, with the central controller or through the AP MLD of the original BSS, during which it is determined where each TID from the non-AP MLD are to map to the links of the target AP MLD in the second BSS; and (d)(vi) wherein the non-AP MLD then roams to the second BSS and can transmit and receive from the AP of that BSS without the need for further negotiation.
A multiple station apparatus for communication in a wireless network, the apparatus comprising: (a) a multiple link device (MLD) having at least two stations, in which each station has at least one modem coupled to at least one radio-frequency (RF) circuit, with each RF circuit configured for connecting to one or multiple antennas, and wherein said MLD is configured for connecting to a central controller through a backhaul communications connection; (b) a processor of said MLD; (c) a non-transitory memory storing instructions executable by the processor for wirelessly communicating with other stations on a IEEE 802.11 wireless local area network (WLAN); and (d) wherein said instructions, when executed by the processor, perform steps of a wireless communications protocol, comprising: (d)(i) wherein said MLD operates a wireless communications protocol as either an access point (AP) MLD having multiple APs, or as non-AP MLD having multiple stations; (d)(ii) wherein said wireless communications protocol incorporates an ultra-high reliability (UHR) mode of IEEE 802.11 be; (d)(iii) wherein each said MLD is configured to allow roaming from a first basic service set (BSS) and an AP MLD, to which it is associated, to a second BSS of a target AP MLD; (d)(iv) wherein a global link ID bitmap information element is configured for communicating identification of non-AP MLDs for which a link recommendation is provided based on a UHR architecture with or without backhaul connection; (d)(v) wherein each AP of any AP MLD, and each non-AP station of any MLD, utilizing the wireless communications protocol is configured for directly or indirectly obtaining a global link identification (ID) from the central controller; said global link ID is issued in a manner that no two APs or non-AP stations, of the same or different MLDs, can obtain the same global link ID, and thus no two APs or non-AP stations are allowed to operate on the links with the same global link ID; (d)(vi) wherein said global link ID is determined by adapting the local association identification (AID) value into a unique global link ID; (d)(vii) wherein said non-AP station requests a global association identification (AID) either directly from the central controller, or from its associated AP, or AP MLP, in which the global AID is understandable by all APs or AP MLDs that are connected with the central controller; (d)(viii) wherein when said MLD is operating as a non-AP MLD, it is configured for transmitting and/or receiving traffic in the first BSS, and prior to roaming to a second BSS, the stations of the non-AP MLD perform a global traffic-identifier (TID)-to-link mapping (TTLM) negotiation, using its global AID, with the central controller or through the AP MLD of the original BSS, during which it is determined where each TID from the non-AP MLD are to map to the links of the target AP MLD in the second BSS; and (d)(ix) wherein the non-AP MLD then roams to the second BSS and can transmit and receive from the AP of that BSS without the need for further negotiation.

A method of communicating between multiple link devices in a wireless network, comprising: (a) performing communications on a IEEE 802.11 wireless local area network (WLAN) between multiple link devices (MLDs), each having at least two stations, in which said MLD is configured for connecting to a central controller; (b) wherein said MLD operates a wireless communications protocol as either an access point (AP) MLD having multiple APs, or as non-AP MLD having multiple stations; (c) wherein each said MLD is configured to allow roaming from a first basic service set (BSS) and an AP MLD, to which it is associated, to a second BSS of a target AP MLD; (d) wherein each AP of any AP MLD, and each non-AP station of any MLD, utilizing the wireless communications protocol is configured for directly or indirectly obtaining a global link identification (ID) from the central controller; said global link ID is issued in a manner that no two APs or non-AP stations, of the same or different MLDs, can obtain the same global link ID, and thus no two APs or non-AP stations are allowed to operate on the links with the same global link ID; (e) wherein said non-AP station requests a global association identification (AID) either directly from the central controller, or from its associated AP, or AP MLP, in which the global AID is understandable by all APs or AP MLDs that are connected with the central controller; (f) wherein when said MLD is operating as a non-AP MLD, it is configured for transmitting and/or receiving traffic in the first BSS, and prior to roaming to a second BSS, the stations of the non-AP MLD perform a global traffic-identifier (TID)-to-link mapping (TTLM) negotiation, using its global AID, with the central controller or through the AP MLD of the original BSS, during which it is determined where each TID from the non-AP MLD are to map to the links of the target AP MLD in the second BSS; and (g) wherein the non-AP MLD then roams to the second BSS and can transmit and receive from the AP of that BSS without the need for further negotiation.

A method of performing wireless communications with one or more AP MLD(s) connecting with the same central controller through wire/wireless backhaul; wherein each AP MLD could support the same or different link configurations and operation capabilities on each supporting operation link; wherein each AP MLD connected with the same central controller could negotiate the global link management such as the TTLM, link recommendation and EML and/or MLD capabilities and operation supports with the non-AP MLD for one time; wherein the non-AP STA as state doesn't need to renegotiate for the link management info such as the TTLM, link recommendation and EML and/or MLD capabilities and operation supports with another AP MLD connecting with the same central controller when/after the non-AP MLD roam to the other AP MLD; wherein each UHR AP MLD should have a global AP MLD ID as obtained by the connected central controller; and wherein the UHR AP MLDs connected to the same central controller could assign Global Link IDs to each of their operation links so that none of their operation link has the same Global Link ID as another link. The apparatus or method of any preceding implementation, wherein said wireless communications protocol comprises an ultra-high reliability (UHR) mode of IEEE 802.11 be.

The apparatus or method of any preceding implementation, wherein said global link ID is determined by adapting the local association identification (AID) value into a unique global link ID.

The apparatus or method of any preceding implementation, wherein a global link ID bitmap information element is configured for communicating identification of non-AP MLDs for which a link recommendation is provided based on a UHR architecture with or without backhaul connection.

The apparatus or method of any preceding implementation, wherein a partial virtual bitmap information element is configured for communication in a traffic indication map (TIM) element configured to adapt TIM for using the global link ID when indicating traffic.

The apparatus or method of any preceding implementation, wherein a global multi-link traffic indication element is configured for communication of a list of per-link traffic indication bitmap(s) corresponding to the global link ID and global AID for non-AP MLDs.

The apparatus or method of any preceding implementation, wherein a multi-Link element is described for carrying Enhanced Multi-Link (EML) and MLD capabilities and operations for multiple AP MLDs that are connected to the same central controller.

The apparatus or method of any preceding implementation, wherein a partial virtual bitmap information element is configured for communication in a traffic indication map (TIM) element configured to adapt TIM for using the global link ID when indicating traffic.

The apparatus or method of any preceding implementation, wherein a global multi-link traffic indication element is configured for communication of a list of per-link traffic indication bitmap(s) corresponding to the global link ID and global AID for non-AP MLDs.

The apparatus or method of any preceding implementation, wherein a multi-Link element is described for carrying Enhanced Multi-Link (EML) and MLD capabilities and operations for multiple AP MLDs that are connected to the same central controller.

The apparatus or method of any preceding implementation, wherein said wireless communications protocol comprises an ultra-high reliability (UHR) mode of IEEE 802.11 be.

The apparatus or method of any preceding implementation, wherein said global link ID is determined by adapting the local association identification (AID) value into a unique global link ID.

The apparatus or method of any preceding implementation, wherein a global link ID bitmap information element is configured for communicating identification of non-AP MLDs for which a link recommendation is provided based on a UHR architecture with or without backhaul connection.

The apparatus or method of any preceding implementation, wherein a partial virtual bitmap information element is configured for communication in a traffic indication map (TIM) element configured to adapt TIM for using the global link ID when indicating traffic.

The apparatus or method of any preceding implementation, wherein a global multi-link traffic indication element is configured for communication of a list of per-link traffic indication bitmap(s) corresponding to the global link ID and global AID for non-AP MLDs.

The apparatus or method of any preceding implementation, wherein a multi-Link element is described for carrying Enhanced Multi-Link (EML) and MLD capabilities and operations for multiple AP MLDs that are connected to the same central controller.

The apparatus or method of any preceding implementation, wherein the Global Link ID can be indicated by standalone ID or Global Link ID or by a combination of Global AP MLD ID and local Link ID.

The apparatus or method of any preceding implementation, wherein different Global Link ID Info fields can be configured.

The apparatus or method of any preceding implementation, wherein the UHR AP MLD can assign non-AP MLD a global AID value, with the assistance of the connected central controller.

The apparatus or method of any preceding implementation, wherein the new global AID Bitmap element to indicate the global AID is designed to adapt the AID value to global AID value.

The apparatus or method of any preceding implementation, wherein the new Global TTLM element is designed to indicate whether to enable the global TTLM capability and to adapt the length of the Link Mapping of TID n field to fit the Global Link ID.

The apparatus or method of any preceding implementation, wherein the New Global Multi-Link Traffic Indication element is designed to contain a list of per-link traffic indication bitmap(s) corresponding to the Global Link ID and Global AID for non-AP MLDs.

The apparatus or method of any preceding implementation, wherein the new Multi-Link element is designed to carry the multiple AP MLD's Capabilities and Supported operation information in the same Multi-Link element.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to 5°, less than or equal to 4°, less than or equal to 3°, less than or equal to ±2°, less than or equal to 1°, less than or equal to 0.5°, less than or equal to 0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A multiple station apparatus for communication in a wireless network, the apparatus comprising:
(a) a multiple link device (MLD) having at least two stations, in which each station has at least one modem coupled to at least one radio-frequency (RF) circuit, with each RF circuit configured for connecting to one or multiple antennas, and wherein said MLD is configured for connecting to a central controller through a backhaul communications connection;
(b) a processor of said MLD;
(c) a non-transitory memory storing instructions executable by the processor for wirelessly communicating with other stations on a IEEE 802.11 wireless local area network (WLAN); and
(d) wherein said instructions, when executed by the processor, perform steps of a wireless communications protocol, comprising:
(i) wherein said MLD operates a wireless communications protocol as either an access point (AP) MLD having multiple APs, or as non-AP MLD having multiple stations;
(ii) wherein each said MLD is configured to allow roaming from a first basic service set (BSS) and an AP MLD, to which it is associated, to a second BSS of a target AP MLD;
(iii) wherein each AP of any AP MLD, and each non-AP station of any MLD, utilizing the wireless communications protocol is configured for directly or indirectly obtaining a global link identification (ID) from the central controller; said global link ID is issued in a manner that no two APs or non-AP stations, of the same or different MLDs, can obtain the same global link ID, and thus no two APs or non-AP stations are allowed to operate on the links with the same global link ID;
(iv) wherein said non-AP station requests a global association identification (AID) either directly from the central controller, or from its associated AP, or AP MLP, in which the global AID is understandable by all APs or AP MLDs that are connected with the central controller;
(v) wherein when said MLD is operating as a non-AP MLD, it is configured for transmitting and/or receiving traffic in the first BSS, and prior to roaming to a second BSS, the stations of the non-AP MLD perform a global traffic-identifier (TID)-to-link mapping (TTLM) negotiation, using its global AID, with the central controller or through the AP MLD of the original BSS, during which it is determined where each TID from the non-AP MLD are to map to the links of the target AP MLD in the second BSS; and
(vi) wherein the non-AP MLD then roams to the second BSS and can transmit and receive from the AP of that BSS without the need for further negotiation.

2. The apparatus of claim 1, wherein said wireless communications protocol comprises an ultra-high reliability (UHR) mode of IEEE 802.11 be.

3. The apparatus of claim 1, wherein said global link ID is determined by adapting the local association identification (AID) value into a unique global link ID.

4. The apparatus of claim 1, wherein a global link ID bitmap information element is configured for communicating identification of non-AP MLDs for which a link recommendation is provided based on a UHR architecture with or without backhaul connection.

5. The apparatus of claim 1, wherein a partial virtual bitmap information element is configured for communication in a traffic indication map (TIM) element configured to adapt TIM for using the global link ID when indicating traffic.

6. The apparatus of claim 1, wherein a global multi-link traffic indication element is configured for communication of a list of per-link traffic indication bitmap(s) corresponding to the global link ID and global AID for non-AP MLDs.

7. The apparatus of claim 1, wherein a multi-Link element is described for carrying Enhanced Multi-Link (EML) and MLD capabilities and operations for multiple AP MLDs that are connected to the same central controller.

8. A multiple station apparatus for communication in a wireless network, the apparatus comprising:
(a) a multiple link device (MLD) having at least two stations, in which each station has at least one modem coupled to at least one radio-frequency (RF) circuit, with each RF circuit configured for connecting to one or multiple antennas, and wherein said MLD is configured for connecting to a central controller through a backhaul communications connection;
(b) a processor of said MLD;
(c) a non-transitory memory storing instructions executable by the processor for wirelessly communicating with other stations on a IEEE 802.11 wireless local area network (WLAN); and
(d) wherein said instructions, when executed by the processor, perform steps of a wireless communications protocol, comprising:
(i) wherein said MLD operates a wireless communications protocol as either an access point (AP) MLD having multiple APs, or as non-AP MLD having multiple stations;
(ii) wherein said wireless communications protocol incorporates an ultra-high reliability (UHR) mode of IEEE 802.11 be;
(iii) wherein each said MLD is configured to allow roaming from a first basic service set (BSS) and an AP MLD, to which it is associated, to a second BSS of a target AP MLD;
(iv) wherein a global link ID bitmap information element is configured for communicating identification of non-AP MLDs for which a link recommendation is provided based on a UHR architecture with or without backhaul connection;
(v) wherein each AP of any AP MLD, and each non-AP station of any MLD, utilizing the wireless communications protocol is configured for directly or indirectly obtaining a global link identification (ID) from the central controller; said global link ID is issued in a manner that no two APs or non-AP stations, of the same or different MLDs, can obtain the same global link ID, and thus no two APs or non-AP stations are allowed to operate on the links with the same global link ID;
(vi) wherein said global link ID is determined by adapting the local association identification (AID) value into a unique global link ID;
(vii) wherein said non-AP station requests a global association identification (AID) either directly from the central controller, or from its associated AP, or AP MLP, in which the global AID is understandable by all APs or AP MLDs that are connected with the central controller;
(viii) wherein when said MLD is operating as a non-AP MLD, it is configured for transmitting and/or receiving traffic in the first BSS, and prior to roaming to a second BSS, the stations of the non-AP MLD perform a global traffic-identifier (TID)-to-link mapping (TTLM) negotiation, using its global AID, with the central controller or through the AP MLD of the original BSS, during which it is determined where each TID from the non-AP MLD are to map to the links of the target AP MLD in the second BSS; and
(ix) wherein the non-AP MLD then roams to the second BSS and can transmit and receive from the AP of that BSS without the need for further negotiation.

9. The apparatus of claim 8, wherein a partial virtual bitmap information element is configured for communication in a traffic indication map (TIM) element configured to adapt TIM for using the global link ID when indicating traffic.

10. The apparatus of claim 8, wherein a global multi-link traffic indication element is configured for communication of a list of per-link traffic indication bitmap(s) corresponding to the global link ID and global AID for non-AP MLDs.

11. The apparatus of claim 8, wherein a multi-Link element is described for carrying Enhanced Multi-Link (EML) and MLD capabilities and operations for multiple AP MLDs that are connected to the same central controller.

12. A method of communicating between multiple link devices in a wireless network, comprising:
(a) performing communications on a IEEE 802.11 wireless local area network (WLAN) between multiple link devices (MLDs), each having at least two stations, in which said MLD is configured for connecting to a central controller;
(b) wherein said MLD operates a wireless communications protocol as either an access point (AP) MLD having multiple APs, or as non-AP MLD having multiple stations;
(c) wherein each said MLD is configured to allow roaming from a first basic service set (BSS) and an AP MLD, to which it is associated, to a second BSS of a target AP MLD;
(d) wherein each AP of any AP MLD, and each non-AP station of any MLD, utilizing the wireless communications protocol is configured for directly or indirectly obtaining a global link identification (ID) from the central controller; said global link ID is issued in a manner that no two APs or non-AP stations, of the same or different MLDs, can obtain the same global link ID, and thus no two APs or non-AP stations are allowed to operate on the links with the same global link ID;
(e) wherein said non-AP station requests a global association identification (AID) either directly from the central controller, or from its associated AP, or AP MLP, in which the global AID is understandable by all APs or AP MLDs that are connected with the central controller;
(f) wherein when said MLD is operating as a non-AP MLD, it is configured for transmitting and/or receiving traffic in the first BSS, and prior to roaming to a second BSS, the stations of the non-AP MLD perform a global traffic-identifier (TID)-to-link mapping (TTLM) negotiation, using its global AID, with the central controller or through the AP MLD of the original BSS, during which it is determined where each TID from the non-AP MLD are to map to the links of the target AP MLD in the second BSS; and
(g) wherein the non-AP MLD then roams to the second BSS and can transmit and receive from the AP of that BSS without the need for further negotiation.

13. The method of claim 12, wherein said wireless communications protocol comprises an ultra-high reliability (UHR) mode of IEEE 802.11 be.

14. The method of claim 12, wherein said global link ID is determined by adapting the local association identification (AID) value into a unique global link ID.

15. The method of claim 12, wherein a global link ID bitmap information element is configured for communicating identification of non-AP MLDs for which a link recommendation is provided based on a UHR architecture with or without backhaul connection.

16. The method of claim 12, wherein a partial virtual bitmap information element is configured for communication in a traffic indication map (TIM) element configured to adapt TIM for using the global link ID when indicating traffic.

17. The method of claim 12, wherein a global multi-link traffic indication element is configured for communication of a list of per-link traffic indication bitmap(s) corresponding to the global link ID and global AID for non-AP MLDs.

18. The method of claim 12, wherein a multi-Link element is described for carrying Enhanced Multi-Link (EML) and MLD capabilities and operations for multiple AP MLDs that are connected to the same central controller.
